(19) United States
(12) Patent Application Publication
(10) Pub. No.: US 2025/0298197 A1
(43) Pub. Date: Sep. 25, 2025

(54) LENSED OPTICAL FIBER COMPRISING AN OPTICAL FIBER AT THE DISTAL END CLEAVED AT 90 DEGREES AND FUSED WITH A LENS ON THE EXTERNAL SURFACE OF WHICH A CONCAVE MIRROR IS FORMED

(71) Applicant: RADIALL, Aubervilliers (FR)

(72) Inventors: Victor LICCHESI, LA VERPILLIERE (FR); Florent BUTTIN, BEVENAIS (FR)

(21) Appl. No.: 19/084,390

(22) Filed: Mar. 19, 2025

(30) Foreign Application Priority Data
Mar. 21, 2024 (FR) 2402841

(51) Int. Cl. G02B 6/42

(52) U.S. Cl. CPC G02B 6/4214; G02B 6/4243

(57) ABSTRACT

A lensed optical fiber including an optical fiber cleaved at the far end at 90° and fused with a lens on the external surface of which is formed a concave mirror. A lensed optical fiber including an optical lens, preferably end-fused to an optical fiber cut at right angles, and the shape of which, and in particular of its external surface, which shape is perfectly controlled, allows a catadioptric optical system or concave mirror with a steering angle to be produced in order to adapt and optimize optical flows entering or exiting between an optical fiber and an optoelectronic component, in transmission or reception.

### TECHNICAL FIELD

The present invention relates to the field of optical fibers, and more particularly of lensed optical fibers, intended for optical and/or data transmission.

By lensed optical fiber, what is meant is an optical fiber one of the ends of which, called the far end, is extended by an optical element configured to re-shape an optical flow entering or exiting the fiber.

The invention also relates to an optical subassembly (OSA) combining one or more optoelectronic components and one or more lensed optical fibers.

The invention also relates to a transmitter subassembly, intended to convert an electrical signal into an optical signal, and to a receiver subassembly intended to convert an optical signal into an electrical signal.

The invention also relates to an optoelectronic module incorporating one or more subassemblies, on a circuit board in a housing.

The invention also relates to a transceiver module combining a receiver subassembly and a transmitter subassembly sharing common electronic circuits and a common circuit board.

One preferred application of the invention relates to optoelectronic modules that in particular are intended to be employed in the field of aerospace, in the field of space technology, in the field of defense, in the field of transport or medicine or even in the field of telecommunications, the field of data communications or the field of industry.

Although described with reference to such preferred application, the invention may be applied to any system requiring a lensed optical fiber.

### PRIOR ART

Systems for forming an optical link are known that use optoelectronic modules and an optical channel made up of one or more optical fibers. Each transmitting or receiving optoelectronic module consists of a circuit board, of an optoelectronic component and of its electronic control component, of one or more optical fibers (which may be concatenated into ribbons) and of an optical device for coupling the one or more optoelectronic components and the one or more optical fibers.

As an optical coupling device, it is known to employ a lensed optical fiber to couple optical flows between said optical fiber and an optoelectronic component. In transmission, the optical flow is thus optimized between an optical or light source, such as a light-emitting diode (LED) or a laser or vertical-cavity surface-emitting laser (VCSEL), and the optical fiber (waveguide) transporting the optical flow with a view to transmitting an optical signal. In reception, the optical flow is optimized between the optical fiber and the receiver of light (photodiode, etc.).

The patent EP1481274B1 discloses, according to one embodiment, a pigtail optical fiber, i.e. an optical fiber that is not connected at one of its ends, called the near end, and the far end of which is fused with a plurality of contiguous optical elements including two spacer rods taking the form of segments of coreless optical fiber of single refractive index, which segments are arranged on either side of a gradient-index (GRIN) optical lens, ending with a bevel coated with a reflective aspherical surface that forms the free end. Alternatively, instead of the bevel and of the reflective aspherical surface, a curved surface is provided at the end of the far spacer rod, so that an optical signal directed against this curved surface is bent. Whatever the embodiment, this solution is complex and expensive to manufacture and furthermore does not allow an optical beam exiting directly from the pigtail optical fiber to be concentrated. Specifically, in all the embodiments disclosed in the above patent, the optical fiber is always equipped, at its far end, with at least one GRIN lens allowing the optical beam to be collimated before reaching the plane or concave mirror. Thus, removal of such a GRIN lens would lead to a lack of convergence or parallelization of the optical beam, leading to a loss of optical flow, at the entrance of the optical fiber or at the optoelectronic component.

Patent application US2021/341688 discloses an optical system for coupling optical fibers and a VCSEL, which comprises an optical ferrule connector comprising a body beveled at an angle of about 45° at its far end and optical fibers oriented coplanar to the beveled surface of the body, and a concave mirror produced at the end of certain of the fibers. This solution is also complex and expensive to manufacture. Furthermore, a 45° bevel implies additional difficulty that is encountered when positioning the optical axis at the exit of the fiber on the beveled surface, because the intersection between the beveled surface of the end of the fiber and the cylinder forming the envelope of the core of the optical fiber forms an ellipse. This therefore leads to less than perfect accuracy when positioning the concave mirror with respect to the optical axis of the fiber. Moreover, the complexity of positioning the lens with respect to the optical axis may lead to longer, and therefore more expensive, adjustments during manufacture. Lastly, the optical flow to or from the VCSEL passes through at least one material of one of the optical fibers, in particular the cladding of the optical fiber, this complicating calculation of the path of the optical flow. In addition, this solution does not allow a plane surface referencing the angular orientation of the lens about the axis of the optical fiber to be obtained.

There is therefore a need to improve lensed optical fibers, in particular lensed optical fibers intended to achieve optical coupling to an optoelectronic component, in order to overcome the aforementioned drawbacks.

The invention aims to meet this need fully or partially.

### SUMMARY OF THE INVENTION

To do this, one subject of the invention, according to one of its aspects, is a unitary lensed optical fiber comprising:
an optical fiber of longitudinal axis (X), the far end of which is a plane surface orthogonal to the longitudinal axis;
a main optical lens of single refractive index, arranged at the far end of the fiber and the external surface of which is delineated at least by a concave segment and a plane segment, parallel or inclined at a non-zero angle to the longitudinal axis of the fiber, the main optical lens being integrally formed on the far end of the optical fiber, so as to form one piece with the latter;
a mirror conforming to at least part of the concave segment of the main lens, the mirror being at least partly reflective in at least one given wavelength range, such that at least some of an optical beam coming from the fiber and passing through the main lens is reflected by the mirror so as to exit via the plane segment of the main lens or vice versa, and such that at least some of an optical beam passing through the plane segment of the main lens and passing through the main lens is reflected by the mirror so as to exit via the fiber.

By “concave”, what is meant here and in the context of the invention is a surface the dip of which is oriented toward the optical fiber.

Advantageously, the main optical lens is fused with the optical fiber so as to form one piece.

According to one advantageous embodiment, the lensed optical fiber comprises an additional optical lens, arranged on the surface of the plane segment.

In one advantageous configuration, the external surface of the main optical lens is also delineated by a free end segment of height (e) greater than or equal to 100 nm.

In this configuration and according to an advantageous feature, the external surface of the main optical lens is delineated by a right parallelepiped, one face of which is the plane segment and another face of which is the free end segment of non-zero height.

In another advantageous configuration, the external surface of the main optical lens is also delineated by a rounded segment conforming at least partly to the outer diameter of the optical fiber.

Preferably, the thickness (e′) of the rounded segment is greater than or equal to 100 nm.

Advantageously, the height of the main lens is less than or equal to the outer radius of the optical fiber.

Also advantageously, the concave segment of the external surface of the main lens, and where appropriate of the additional one, is a biconical surface, and preferably a double-paraboloid.

Preferably, the material of the main lens, and where appropriate of the additional one, is transparent in the given wavelength range, which is preferably between 800 and 1700 nm.

The material from which the main lens is made, and where appropriate the material from which the additional lens is made, may be selected from transparent polymers or a glass that is transparent at the wavelength used, which is preferably between 800 and 1700 nm. It may be a question of a photopolymer resin, such as an epoxide, an acrylate or a combination thereof, an unsaturated polyester, a urethane, or a sol-gel. It may also be a question of a thermoplastic resin, such as polyethyleneimine (PEI) or polyamide-imide (PAI).

According to a first variant of embodiment, the mirror is a metal layer, preferably a layer of a metal selected from Au, Al, Ni and Ag, deposited on the concave segment of the lens.

According to a second variant of embodiment, the mirror is a dielectric layer that is reflective in the given wavelength range.

According to one advantageous embodiment, the unitary lensed optical fiber comprises at least one projection, and preferably two projections arranged on either side of the mirror, protruding beyond the free end segment of the external surface, the one or more projections being intended to abut axially against a holder in order to position the optical fiber axially.

Advantageously, each projection comprises an abutment zone, preferably taking the form of a plane face, orthogonal to the longitudinal axis (X) of the optical fiber. It is thus possible to guarantee that a plane-plane joint is formed as axial abutment.

Also advantageously, the one or more projections are made of the same material as the optical lens. These one or more projections may advantageously be produced during additive manufacture of the optical lens. Alternatively, the one or more projections may also be printed on top of an already formed lens and/or made of a material with different mechanical properties from the material of the lens. Whatever the variant of embodiment, the geometry of the one or more projections must permit access to the surface of the optical lens in order to allow deposition to be carried out to form the mirror, this being why there is an empty space between two projections arranged on either side of the lens.

In one advantageous configuration, the one or more projections are produced in such a way as to be circumscribed transversely in the cross section of the optical fiber.

The one or more projections according to this embodiment make it possible to improve passive axial positioning of the lensed fiber in a groove of a holder for lensed fibers, in particular a silicon substrate. This makes it possible to correctly position the optical flow with respect to the optoelectronic component, such as a laser or photodiode, to which the optical fiber must be coupled.

This positioning is advantageously completely passive, because by virtue of the mechanical abutment into which the one or more projections are brought, there is no need to use an optical-signal transmission and a complex measuring bench to calibrate the positioning.

Detection of actual abutment, in particular by a force sensor or an optical observation of the mechanical contact, alone is sufficient to guarantee the sought correct axial positioning.

The projections may take various forms, in particular when the optical lens has an external surface comprising a prism.

According to one variant of embodiment, a projection may take the form of a horn extending from the free end segment of a right prism.

The invention also relates to an optical subassembly, comprising:
at least one unitary lensed optical fiber such as described above,
at least one optoelectronic component arranged at a distance from and facing the plane segment of the main lens parallel or inclined at a non-zero angle to the longitudinal axis of the fiber.

Preferably, the space between the optoelectronic component and the plane segment of the main lens, or where appropriate with the additional lens, is filled with air, filled with a resin that is transparent in the given wavelength range or filled with an adhesive that is transparent in the given wavelength range.

According to one multi-channel embodiment, the subassembly comprises:
a holder comprising a plurality of preferably V-shaped grooves,
a plurality of lensed optical fibers each positioned and blocked in one of the grooves,
a strip of a plurality of optoelectronic components, arranged on the holder with each of the optoelectronic components arranged at a distance from and facing the plane segment of the main lens of one of the optical fibers.

The invention also relates to an optoelectronic module, comprising at least one optical subassembly such as described above.

Lastly, the invention relates to a process for producing a unitary lensed optical fiber such as described above, comprising the following steps:
i/ positioning an optical fiber on a holder,
ii/ cutting at 90°, in particular by cleaving, and preparing the far end of the optical fiber,
iii/ dipping or submerging the far end of the optical fiber into a photopolymer resin,
iv/ polymerizing the resin by laser polymerization in order to form an external surface of the main optical lens, which external surface is delineated at least by a concave segment and a plane segment, parallel to the longitudinal axis of the optical fiber,
v/ depositing an at least partially reflective material on all or some of the concave segment of the external surface of the main lens, so as to form the mirror.

Step i/ may be carried out before step ii/ or conversely, step ii/ may be carried out before step i/.

By “preparing”, what is meant here and in the context of the invention is any conventional surfacing step carried out to ensure the end surface of the optical fiber has a desired finish, in particular a high planarity and a low roughness—cleaving and/or polishing for example.

By “soaking”, what is meant here and in the context of the invention is submerging the end of an optical fiber in a bath of photopolymer resin and then taking it out of the bath before the start of polymerization, in the drop remaining by capillary action at the end of the fiber.

By “submerging”, what is meant here and in the context of the invention is submerging the end of an optical fiber in a bath of photopolymer resin and leaving it in the bath during polymerization.

Step iv/ is advantageously carried out by two photon photopolymerization (2PP).

Thus, the invention essentially consists in a unitary lensed optical fiber comprising an optical lens, preferably end-fused to an optical fiber cut at right angles, and the shape of which, and in particular of its external surface, which shape is perfectly controlled, allows a catadioptric optical system or concave mirror with a steering angle to be produced in order to adapt and optimize optical flows entering or exiting between an optical fiber and an optoelectronic component, in transmission or reception.

The optical lens is integrally formed on the far end of the optical fiber, thereby forming one piece with the optical fiber, advantageously by photopolymerization-based, preferably laser-photopolymerization-based, additive or 3D printing, on the optical fiber, of a material that is transparent to the wavelengths used, before a reflective treatment is applied to obtain the catadioptric surface defining the mirror.

Control of the shape of an optical fiber and of the surface finish of the optics makes it possible to guarantee the optical flow is guided between the fiber and the optoelectronic component. Printing a transparent material by laser polymerization directly on the fiber is a simple and well-characterized process. Once the material has been printed and has stabilized, the external surface of the concave segment of the printed optical lens is rendered completely or partially reflective by defining a mirror for a given wavelength or wavelength range.

Thus, the invention has many advantages over prior-art lensed optical fibers, among which mention may be made of:
a decrease in signal losses due to implementation of a mirror on the concave segment of the lens, compared to implementation of a plane mirror in the prior art, and thus an improvement in the efficiency of the signal transmission;
a decrease in signal losses due to the focus of the optical beam by the concave mirror, as close as possible to the optical fiber or optoelectronic component, and thus an improvement in the efficiency of the signal transmission;
a high accuracy in the positioning of the lens due to cutting, also called right cleaving, at 90° of the axis of the fiber;
the optical flow in the direction of the optoelectronic component remains in the transparent material of the lens and never passes back through the optical fiber, this simplifying calculation of the path of the optical flow;
greater control of the shape of the lens, achieved through a laser-polymerization-based technique of additive manufacturing directly on the tip of a previously prepared optical fiber;
easier positioning and manufacture of the mirror with respect to the axis of the fiber, made possible by the 90° cleave of the fiber defining a circular reference frame (diameter of the core of the fiber);
positioning of the optical fiber in a printer for additively manufacturing the lens facilitated by the 90° cleave of the fiber;
it is easier to focus on the interface with an optical fiber cleaved at 90°;
the fact there is no need to add material around the fiber, but only at one end, to make the lens, allows mounting in a V-shaped groove;
the unitary optical fiber equipped with its optical lens, which does not protrude from the cross section of the optical fiber, may be slid into a V-shaped groove of a holder with a view to manufacture of an optical subassembly (OSA);
in a multi-fiber version of the optical subassembly (OSA) taking the form of a ribbon, angular positioning of the fibers flat is facilitated on the one hand by the plane surface of the plane segment of the external surface of the optical lens and on the other hand by the axis of alignment of the various optical fibers of the ribbon. On the latter point, the plane passing through the optical axes of all the fibers makes it possible to orient production of a right prism forming part of the external surface of the lens.
direct/in situ additive manufacturing of the lens on the optical fiber, making it possible to avoid an additional step of assembly, to attach an optical system manufactured separately, by molding or overmolding for example;
the ability to print different shapes and sizes of lenses for each of the fibers of an array of fibers;
the ability to adapt the lens on a case-by-case basis, for example taking into account an entering or exiting light flux, or different wavelengths;
unitary positioning of the optical lens as desired on the optical fiber, thus optimizing its position with respect to the core of the fiber;
because unitary manufacture by 2PP 3D printing is possible, flexibility to change lens shapes, a lower cost compared to a molding-based process, and the ability to quickly test various lens shapes and to adjust focus. Other advantages and features of the invention will become more clearly apparent on reading the detailed description of examples of implementation of the invention, which description is non-limiting and given by way of illustration, with reference to the following figures.

### BRIEF DESCRIPTION OF THE DRAWINGS

FIG. 1 shows a longitudinal cross-sectional view of one example of a lensed optical fiber according to the invention.

FIG. 2 is a perspective view of the lensed optical fiber in FIG. 1.

FIG. 3 is a perspective view of one example of a lensed optical fiber according to one alternative and one variant of embodiment of the optical lens according to the invention.

FIG. 4 shows a longitudinal cross-sectional view of an optical subassembly comprising a lensed optical fiber as shown in FIGS. 1 and 2 and an optoelectronic component on its substrate.

FIG. 5 is a perspective view of the optical subassembly in FIG. 4.

FIG. 6 is a perspective view of one example of a lensed optical fiber according to one variant of embodiment of the optical lens according to the invention.

FIG. 7 is a perspective view showing one example of a multi-channel optical subassembly comprising a plurality of lensed optical fibers according to the invention and a strip of optoelectronic components on a suitable holder.

FIG. 8 is a perspective view of one embodiment of an optical lens mounted on the tip of an optical fiber, which optical lens comprises two protruding projections allowing positioning through axial abutment according to a first variant of embodiment according to the invention.

FIG. 9 is a perspective view illustrating a second variant of the embodiment of the optical lens with two protruding projections allowing positioning through axial abutment.

FIG. 10 is a perspective view illustrating a third variant of the embodiment of the optical lens with two protruding projections allowing positioning through axial abutment.

FIG. 11 is a longitudinal cross-sectional and perspective view illustrating axial abutment of a unitary lensed optical fiber incorporating projections according to the second variant illustrated in FIG. 9.

FIG. 12 reprises FIG. 11 but merely in longitudinal cross-sectional view.

### DETAILED DESCRIPTION

In the following description and throughout the present patent application, the terms “far” and “near” are used with reference to an optical flow through a lensed optical fiber according to the invention. Thus, the far end is the end of the fiber comprising the optical lens and mirror of the invention through which an optical flow having traced the optical fiber exits.

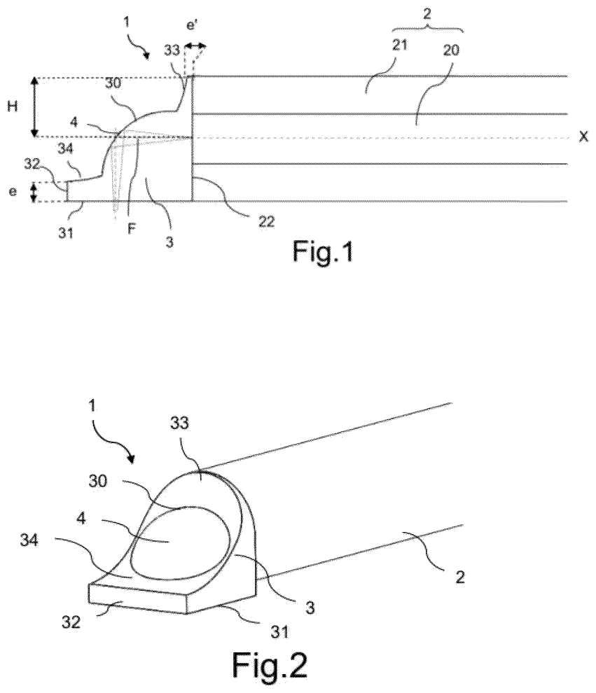

FIGS. 1 and 2 show one example of a lensed optical fiber according to the invention, designated overall by the reference 1.

This lensed fiber 1 firstly comprises an optical fiber 2 of longitudinal axis (X) comprising a core 20 and a cladding 21 encircling the core 20.

The far end 22 of the fiber 2 is a plane surface orthogonal to the longitudinal axis X.

A main optical lens 3 of single refractive index is arranged at the far end 22 of the fiber. Preferably, the optical lens is integrally formed, i.e. fused, with the fiber and therefore forms one piece with the latter.

The external surface of this main lens 3 is delineated by a concave segment 30 and a plane segment 31 parallel to the longitudinal axis X or inclined at a non-zero angle with respect to the longitudinal axis X. This angle may be a few tens of degrees.

Preferably, the concave segment 30 is a biconical surface, advantageously a double-paraboloid.

This plane segment 31 is a face of a right parallelepiped, another face 32 of which is the free end segment of the lens of non-zero height e. Preferably, this height e is at least equal to 100 nm. For reasons of robustness of the face 32, the height e is preferably at least 20 μm, or even preferably at least 50 μm. The minimum height e makes it possible to avoid having a tip that is fragile, and therefore likely to break during manipulation of the lensed fiber, for example when it is placed in position in a holder 9.

This plane segment 31 may be used as a mechanical joint with a surrounding element or as a reference surface to define an angular orientation with respect to the longitudinal axis X of the optical fiber. In other words, the plane segment 31 makes it possible to orient the concave segment angularly in rotation about the axis X of the optical fiber, and therefore to orient the optical flow exiting the lens with respect to said axis X.

Furthermore, the external surface of the optical lens 3 is also delineated by a segment 33 that is rounded in a plane perpendicular to the axis X, and that at least partly conforms to the outer diameter of the optical fiber 2.

The thickness e′ of the end of the rounded segment 33 of the prism makes it possible to ensure adhesion between the lens, during its manufacture, and the far end 22 of the fiber. The thickness e′ is preferably at least 100 nm. In the case of optical fibers arranged in a ribbon, the thickness e′ may have a different value depending on the fiber in question, in order to compensate for any differences in length between fibers of the ribbon following the cleaving operation.

Lastly, another rounded segment 34 may join the concave segment 30 and the right parallelepiped.

Advantageously, the height H of the lens 3, defined by the distance between the optical axis of the fiber and the top of the rounded segment 33, is less than or equal to the outer radius of the optical fiber. In other words, the rounded segment 33 is preferably recessed inside the cylindrical envelope of the optical fiber 2. The recessed positioning of the rounded segment 33 with respect to the cylindrical envelope of the optical fiber facilitates assembly of the lensed optical fiber in the holder 9, in particular assembly by sliding in the grooves 90.

The material of the main lens 3 is preferably transparent in a given wavelength range, preferably between 800 and 1700 nm.

The material of the lens 3 is preferably a photopolymer resin, for example an epoxy, acrylate or urethane, or a sol-gel.

A mirror 4 conforms to at least part of the concave segment 30 of the main lens 3. This mirror 4 is at least partly reflective in at least the given wavelength range.

The mirror 4 may be a metal layer, preferably chosen from the chemical elements Au, Al, Ni and Ag, or a dielectric layer that is reflective in the given wavelength range, deposited on the concave segment 30 of the lens. The metal layer makes it possible to reflect all or some of the optical flow. The dielectric layer makes it possible to reflect certain wavelengths, thus forming a wavelength filter.

The operation of the lensed optical fiber is as follows.

As illustrated by the dotted lines in FIG. 1, at least part of an optical beam F coming from the core 20 of the fiber 2 diverges after passing through the far end 22, passes through the lens 2 and is then reflected by the mirror 4 which focuses it, so that it exits, in particular perpendicular to the longitudinal axis X, via the plane segment 31 of the lens. Producing the mirror lens right next to the far end 22 of the optical fiber minimizes the dispersion of the beam before it strikes concave mirror. It also makes it possible to decrease the size of the lens.

In contrast, at least part of an optical beam passing through the plane segment 31 of the lens is reflected by the mirror 4 and exits through the core 20 of the fiber.

The plane segment 31 of the external surface of the main lens 3 makes it possible not to introduce any additional deformation into the optical beam F entering or exiting via this face.

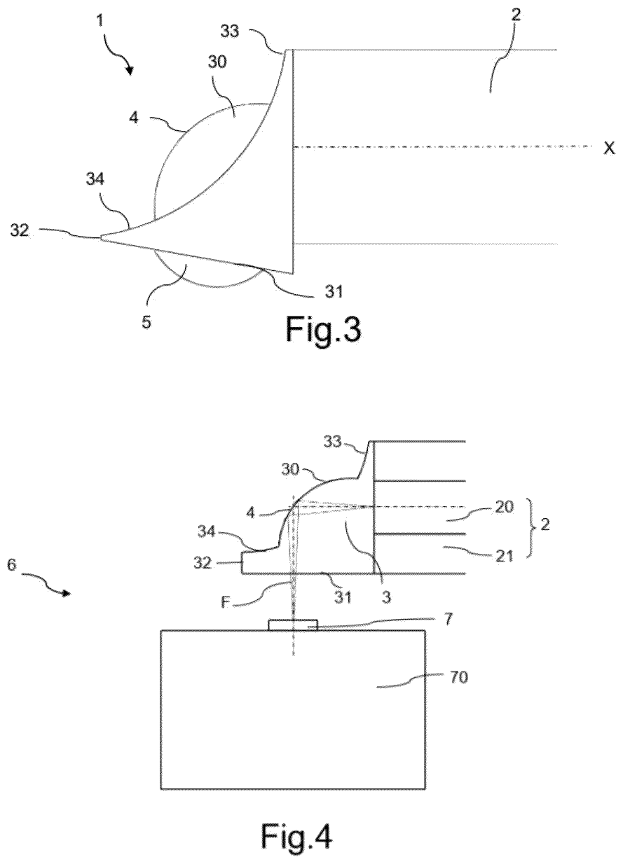

One alternative according to the invention, illustrated in FIG. 3, may consist in producing a plane segment that is not parallel to the longitudinal axis X, i.e. that is inclined at a non-zero angle with respect thereto. Thus, in the case of an optical beam coming from the optical fiber and reflected by the mirror at an angle other than 90°, the beam reflected by the mirror may cross a plane segment 31 not parallel to the longitudinal axis X of the optical fiber perpendicularly, avoiding additional deviation of the path of the beam. In addition, a plane segment 31 inclined at a non-zero angle with respect to the axis of the fiber makes it possible to avoid reflection of the light emitted by a light source back toward itself.

Moreover, compared with the lensed fibers of the prior art comprising a plane mirror and a separate lens, the reflective concave segment of the invention is twice as convergent for a given lens radius. In other words, the optical beam may be focused, toward the optical fiber or toward the surface of the optoelectronic component, over a much shorter distance. Therefore, the reflective concave segment according to the invention makes it possible to obtain an optical system, redirecting and making the optical beam converge, that is much more compact.

One advantageous variant may consist in producing, below the plane segment 31, an additional optical lens 5, also with a single refractive index, in addition to the main lens 3. According to this variant, the plane segment 31 may or may not be parallel to the longitudinal axis X of the fiber.

FIG. 3 thus shows a configuration with the additional optical lens 5 below a plane segment 31 inclined with respect to the longitudinal axis X.

Preferably, the external surface of this additional lens 5 may be biconical, and even more preferably a double paraboloid.

The material of the additional lens 5 is preferably transparent in a given wavelength range, preferably between 800 and 1700 nm.

The material of the lens 5 is preferably a photopolymer resin, for example an epoxy, acrylate or urethane, or a sol-gel.

This additional optical lens 5 makes it possible to further improve the focus of a beam coming from the optical fiber toward an optoelectronic component, and vice versa. This additional lens 5 preferably is one piece with the fiber 2 and the main lens 3.

Thus, in order to produce this complex shape of the main lens 3, and where appropriate the additional optical lens 5, with dimensions that meet the requirements optimally, the inventors have implemented a photopolymerization-based, and preferably laser-photopolymerization-based, additive printing technique. This method makes it possible to produce a compact lens directly on the end of a unitary optical fiber.

More precisely, to produce a lensed optical fiber 1 of the type just described above, the following steps are carried out:
i/ positioning an optical fiber 2 on a holder,
ii/ cutting at 90°, in particular by cleaving, and preparing the far end 22 of the optical fiber,
iii/ dipping or submerging the far end 22 of the optical fiber into a photopolymer resin,
iv/ polymerizing the resin by laser polymerization in order to form an external surface of the optical lens, which external surface is delineated at least by a concave segment 30 and a plane segment 31, which is parallel or inclined at a non-zero angle to the longitudinal axis X of the optical fiber, and in particular has an additional optical lens 5 below the plane segment 31,
v/ depositing an at least partially reflective material on all or some of the concave segment of the external surface of the lens, so as to form the mirror 4.

Step ii/ may be carried out before step i/.

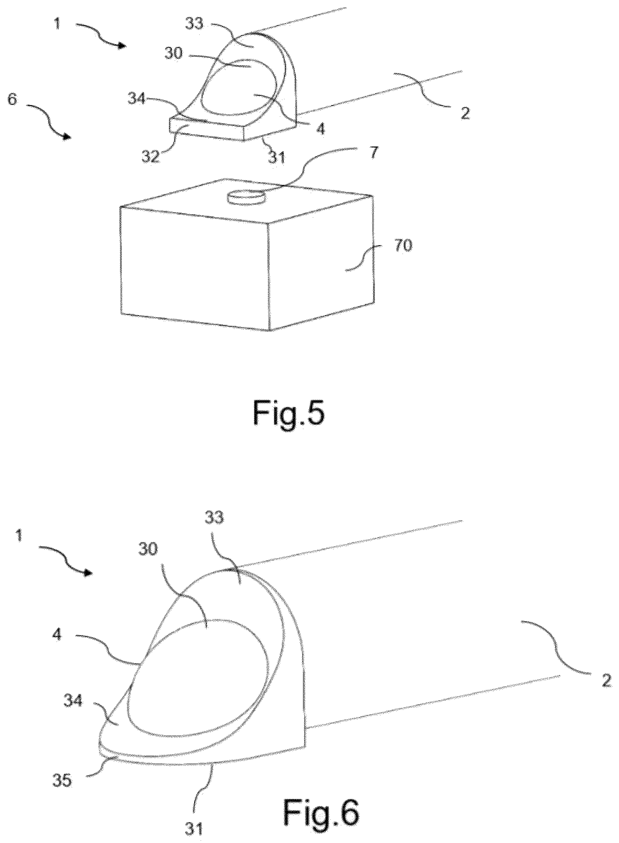

An optical subassembly (OSA) 6 incorporating a lensed optical fiber 1 of the type just described above has been shown in FIGS. 4 and 5.

This subassembly 6 comprises an optoelectronic component 7 arranged at a distance from and facing the plane segment 31 of the main lens 3. The optoelectronic component 7 may be a light source, in particular a VCSEL, or a light receiver, in particular a photodiode. The distance between the plane segment 31 and the surface of the optoelectronic component may vary from a few microns to a few hundred microns.

As shown, the optoelectronic component 7 may be borne by a substrate 70 and the space between the optoelectronic component 7 and the plane segment 31 of the main lens 3, or where appropriate the additional lens 5, is filled with air or a resin that is transparent in the given wavelength range. The resin, which in particular is different from the one used to produce the mirror lens, makes it possible to protect the optical surfaces of the lensed fiber, in particular the plane segment 31 and/or the additional optical lens 5, and/or of the optoelectronic component from mechanical contamination or aggression (scratches, etc.), chemical contamination or aggression or environmental contamination or aggression (moisture, fluids, etc.).

As illustrated in FIG. 4, the optical beam F entering or exiting via the plane segment 31 of the main lens 3 is perfectly focused on the optoelectronic component 7.

FIG. 6 illustrates a variant lens 3 of optimized shape. The right parallelepiped has been replaced by a rounded tapered lateral shape 35 below the concave segment 30. This shape of the external surface optimized with the lateral rounded segment 35 decreases the volume of resin to be polymerized to obtain the lens 3, saving time while maintaining strength. This lateral rounded segment 35 also avoids fragile edges at the base of the right parallelepiped.

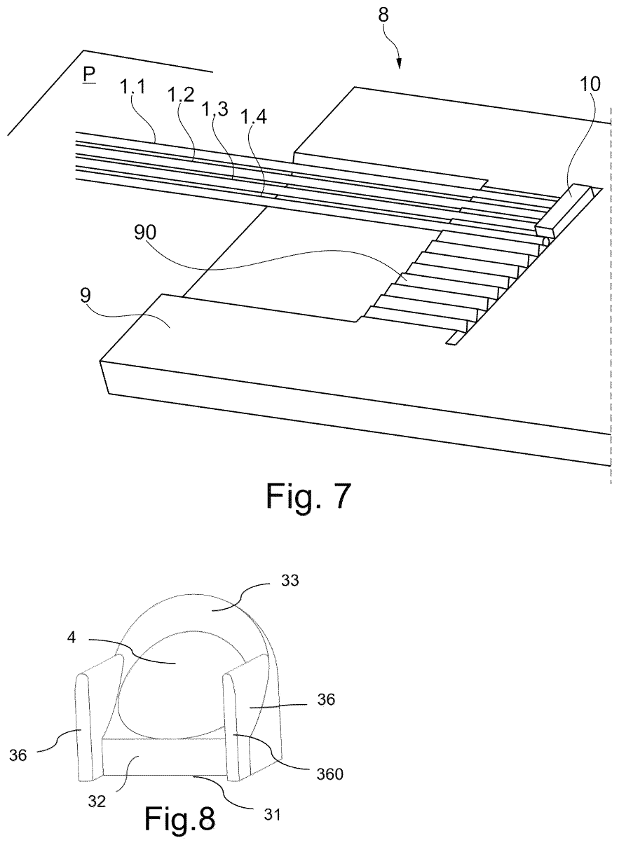

FIG. 7 illustrates an optical subassembly 8 that may be said to have multiple optical channels, i.e. that comprises a plurality of lensed optical fibers 1 forming a ribbon. Each channel may transmit and/or receive signals.

In this subassembly 8, a plurality of lensed optical fibers 1.1, 1.2, 1.3, 1.4 are each positioned and blocked in one of the grooves 90, which are preferably V-shaped, of a holder 9. The rounded segment 33, which conforms at least partly to the outer diameter of the optical fiber 2, or which is advantageously recessed inside the cylindrical envelope of the optical fiber 2, makes it possible to position the lensed fiber in one of the grooves without interference between the latter and the lens. Therefore, this allows the pitch between the grooves, and therefore between the lensed fibers, to be made as small as possible. This allows the most compact possible OSA to be obtained.

In the context of optical fibers arranged in a ribbon, the set of longitudinal axes X of the optical fibers makes it possible to define a common plane P. During production of the lens on each fiber, the common plane P associated with the plane segment 31 of the lens to be produced makes it possible to easily define the angular orientation of each lens with respect to the axis X of its associated optical fiber. Thus, each lens produced on each optical fiber of the ribbon is correctly oriented with respect to the plane P and the longitudinal axis X, and then correctly oriented with respect to the holder 9 receiving the lensed fibers in the grooves 90 of the holder.

A strip 10 of a plurality of optoelectronic components is arranged on the holder with each of the optoelectronic components arranged at a distance from and facing the plane segment 31 of the lens of one of the optical fibers 1.1, 1.2, 1.3, 1.4. The strip 10 may or may not be arranged directly on the holder. It may for example be mounted on an intermediate component itself facing the holder 9.

An optical subassembly OSA of the type illustrated in FIGS. 4 and 5 or in FIG. 7 may be integrated into an optoelectronic module.

FIG. 8 shows an embodiment of an optical lens 3 mounted on the tip of an optical fiber, which optical lens comprises, arranged on either side of the mirror 4, two protruding projections 36 allowing positioning through axial abutment.

As illustrated, the two projections 36 extend from the plane portion 31 from which the optical beam exits and have a segment on the curved external surface 33, beyond the plane face 32 of the lens.

As shown, each projection 36 comprises a plane abutment face 360, which is orthogonal to the longitudinal axis (X) of the optical fiber.

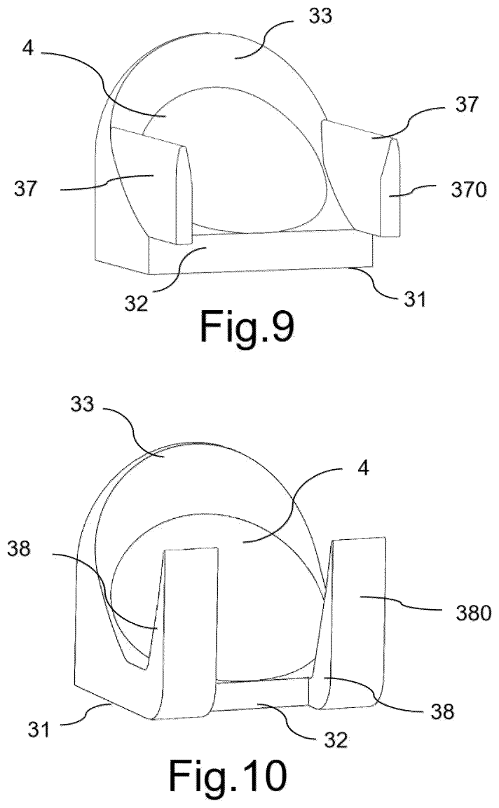

FIG. 9 illustrates an alternative according to which the two protruding projections 37 extend only from the curved external surface 33 and therefore not from the plane segment 31.

Once again, each projection 37 comprises a plane abutment face 370, which is orthogonal to the longitudinal axis (X) of the optical fiber.

FIG. 10 illustrates another alternative according to which the two protruding projections 38 each take the form of a horn extending from the free end segment 32 of the optical lens.

Once again, each projection 38 comprises a plane abutment face 380, which is orthogonal to the longitudinal axis (X) of the optical fiber.

Advantageously, the material of the projections is the same as that of the optical lens.

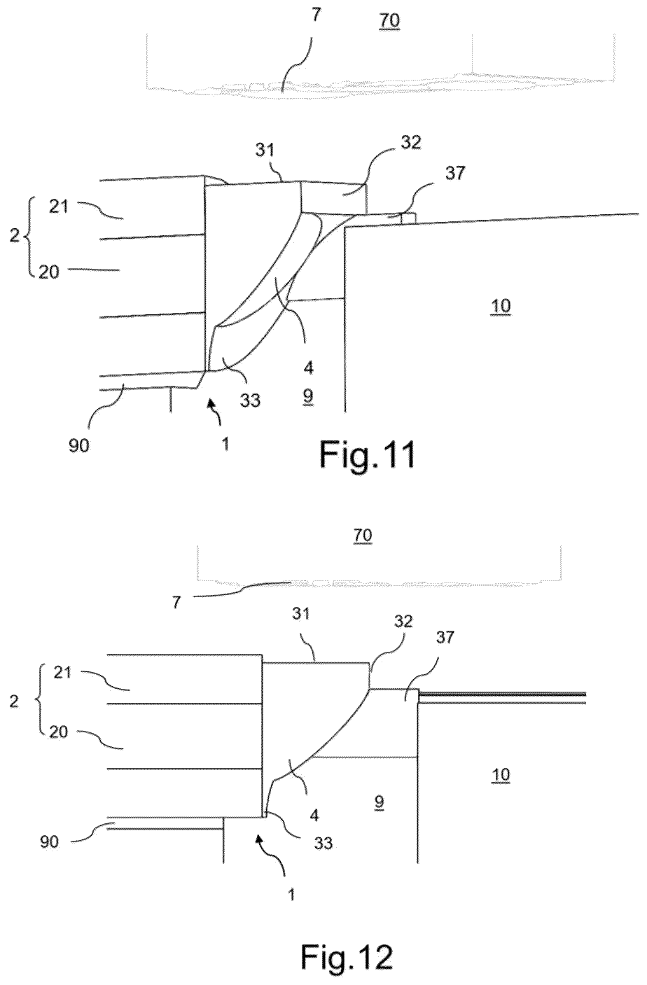

FIGS. 11 and 12 illustrate a unitary lensed optical fiber 1 being brought into axial abutment via projections 37 the plane end face 370 of which bears against a suitable element, which may for example be a zone of a strip 10 of a plurality of optoelectronic components 7. The abutment element may also be a vertical surface of a holder 9, such as a silicon or glass substrate.

The unitary lensed fiber 1 is thus inserted by sliding it into a groove 90, for example a V-shaped grove, in the holder 9 until axial mechanical abutment of the face 370 plumb against the element is detected.

By virtue of this axial mechanical abutment, the mirror 4 is perfectly positioned axially with respect to the optoelectronic component 7 and therefore the optical beam exiting the plane segment 31 is perfectly focused on said component 7.

The zones 360, 370 or 380 are not necessarily plane and the abutment against the suitable element may be linear if the surfaces 360, 370 or 380 are cylindrical. This joint may also be point-like depending on the form of contact selected, without thereby departing from the scope of the invention.

Other variants and improvements may be provided without thereby departing from the scope of the invention.

The shape and/or dimensions of the optical lens may differ from those illustrated and take any form provided that the external surface incorporates a concave segment. They may, for example, partially take the form of a right parallelepiped, inter alia, preferably such that the rounded segment 33 of the lens is recessed inside the cylindrical envelope of the optical fiber.

1. A unitary lensed optical fiber comprising:
an optical fiber of longitudinal axis (X), the far end of which is a plane surface orthogonal to the longitudinal axis;
a main optical lens of single refractive index, arranged at the far end of the fiber and the external surface of which is delineated at least by a concave segment and a plane segment, parallel or inclined at a non-zero angle to the longitudinal axis of the fiber, the optical lens being integrally formed on the far end of the optical fiber, so as to form one piece with the latter;
a mirror conforming to at least part of the concave segment of the main lens, the mirror being at least partly reflective in at least one given wavelength range, such that at least some of an optical beam (F) coming from the fiber and passing through the main lens is reflected by the mirror so as to exit via the plane segment of the main lens or vice versa, and such that at least some of an optical beam passing through the plane segment of the main lens and passing through the main lens is reflected by the mirror so as to exit via the fiber.

2. The lensed optical fiber as claimed in claim 1, the main optical lens being fused with the optical fiber so as to form one piece.

3. The lensed optical fiber as claimed in claim 1, comprising an additional optical lens arranged on the surface of the plane segment.

4. The lensed optical fiber as claimed in claim 1, the height (H) of the main lens being less than or equal to the outer radius of the optical fiber.

5. The lensed optical fiber as claimed in claim 1, the concave segment of the external surface of the main lens, and where appropriate of the additional one, being a biconical surface, and preferably a double-paraboloid.

6. The lensed optical fiber as claimed in claim 1, the material of the main lens, and where appropriate of the additional lens, being transparent in the given wavelength range, which is preferably between 800 and 1700 nm.

7. The lensed optical fiber as claimed in claim 1, the mirror being a metal layer, preferably a layer of a metal selected from Au, Al, Ni and Ag, deposited on the concave segment of the main lens.

8. The lensed optical fiber as claimed in claim 1, the mirror being a dielectric layer that is reflective in the given wavelength range.

9. The lensed optical fiber as claimed in claim 1, comprising at least one projection, and preferably two projections arranged on either side of the mirror, protruding beyond the free end segment of the external surface, the one or more projections being intended to abut axially against a holder in order to position the optical fiber axially.

10. The lensed optical fiber as claimed in claim 10, each projection comprising an abutment zone, preferably taking the form of a plane face, orthogonal to the longitudinal axis (X) of the optical fiber.

11. The lensed optical fiber as claimed in either of claim 9, the one or more projections being produced in such a way as to be circumscribed transversely in the cross section of the lensed fiber.

12. An optical subassembly comprising:
at least one unitary lensed optical fiber as claimed in claim 1,
at least one optoelectronic component arranged at a distance from and facing the plane segment of the main lens parallel or inclined at a non-zero angle to the longitudinal axis (X) of the fiber.

13. The optical subassembly as claimed in claim 12, the space between the optoelectronic component and the plane segment of the main lens, or where appropriate with the additional lens, being filled with air, filled with a resin that is transparent in the given wavelength range or filled with an adhesive that is transparent in the given wavelength range.

14. The optical subassembly as claimed in claim 12, comprising:
a holder comprising a plurality of preferably V-shaped grooves,
a plurality of lensed optical fibers each positioned and blocked in one of the grooves,
a strip of a plurality of optoelectronic components, arranged on the holder with each of the optoelectronic components arranged at a distance from and facing the plane segment of the main lens of one of the optical fibers.

15. A process for producing a unitary lensed optical fiber as claimed in claim 1, comprising the following steps:
i. positioning an optical fiber on a holder,
ii. cutting at 90°, in particular by cleaving, and preparing the far end of the optical fiber,
iii. dipping or submerging the far end of the optical fiber into a photopolymer resin,
iv. polymerizing the resin by laser polymerization in order to form an external surface of the main optical lens, which external surface is delineated at least by a concave segment and a plane segment, which is parallel or inclined at a non-zero angle to the longitudinal axis of the optical fiber, and
v. depositing an at least partially reflective material on all or some of the concave segment of the external surface of the main lens, so as to form the mirror.
